(19) United States
(12) Patent Application Publication
(10) Pub. No.: US 2014/0201073 A1
(43) Pub. Date: Jul. 17, 2014

(54) ENABLEMENT OF MANAGED PRINT "MICRO" SERVICE FOR RETAIL OFFICE CHANNEL

(71) Applicant: XEROX CORPORATION, Norwalk, CT (US)

(72) Inventors: Jack Douglas Jenkins, JR., Tualatin, OR (US); James D. Rise, Lake Oswego, OR (US); James Patrick VanWinkle, West Linn, OR (US); Robin Yuen Wessel, Tigard, OR (US); Charles R. Carlson, Beaverton, OR (US); Shanti Villarreal, Wilsonville, OR (US); Leonard Guan, Happy Valley, OR (US)

(73) Assignee: XEROX CORPORATION, Norwalk, CT (US)

(21) Appl. No.: 13/740,368

(22) Filed: Jan. 14, 2013

(51) Int. Cl. G06Q 20/14

(52) U.S. Cl. CPC G06Q 20/145
USPC 705/40; 705/39

(57) ABSTRACT

Systems and methods are provided for managing a document processing device of a consumer. According to one embodiment, a registration request for a managed print service (MPS) plan is received from a retailer selling the MPS plan to the consumer. The MPS plan includes a plurality of credits. The MPS plan is associated with an MPS account of the consumer based on the registration request, and the document processing device is associated with the MPS plan. Data regarding a remaining life of a consumable of the document processing device or usage of the document processing device is received from the consumer. The credits are decremented based on the received data. The provisioning of a replacement for the consumable to the consumer is coordinated in response to the remaining life of the consumable falling below a threshold and the MPS plan including credits.

### BACKGROUND

The present application relates generally to print services. It finds particular application in conjunction with operation and management of document processing devices, such as printers, scanners, copiers, combination scanner-printer-copier machines, and the like, and will be described with particular reference thereto. However, it is to be appreciated that the present application is also amenable to other like applications.

Institutions, such as business, government and/or academic institutions, often employ document processing devices on site in networked systems to provide users the option of sending a given print job to one of several devices for processing. Institutions employing multiple document processing devices often desire options for financing and tracking printer utilization, and may prefer to pay for print services and related devices and materials based on usage rather than paying up front for equipment and consumable accessories. Moreover, manufacturers and resellers of document processing devices often desire the ability to provide such account options to end-users.

Managed print services (MPSs) provide a solution. However, MPSs, as they exist today, do not have the reach to capture institutions which prefer to handle their printing technology purchases through retail outlets. Further, current MPSs target large institutions and typically have long sales cycles to develop highly involved contracts. The entrance and exit to these contracts are generally too time consuming for smaller institutions. Hence, smaller institutions and/or institutions preferring retail need managed print services scaled so that they can: (1) comprehend the program and cost management opportunities; and (2) exit in a way that is not cost prohibitive to the retail supplier or consumer.

The present application provides new and improved methods and systems which overcome the above-referenced challenges.

### INCORPORATION BY REFERENCE

U.S. patent application Ser. No. 12/696,892 (US Patent Application Publication No. 2011/0191148) for METHODS AND APPARATUS FOR MANAGING PRE-PAID PRINTING SYSTEM ACCOUNTS, by Carlson et al., filed on Jan. 29, 2010, and U.S. patent application Ser. No. 12/696,076 (US Patent Application Publication No. 2011/0191197) for METHODS AND APPARATUS FOR MANAGING CREDIT CARD USAGE IN PRE-PAID PRINTING SYSTEM ACCOUNTS, by VanWinkle et al., filed on Jan. 29, 2010, are each hereby incorporated herein by reference in entirety.

### BRIEF DESCRIPTION

In accordance with one aspect of the present application, a computer-implemented method for managing a document processing device of a consumer is provided. A registration request for a managed print service (MPS) plan is received from a retailer selling the MPS plan to the consumer. The MPS plan includes a plurality of credits. The MPS plan is associated with an MPS account of the consumer based on the registration request, and the document processing device is associated with the MPS plan. Data regarding a remaining life of a consumable of the document processing device or usage of the document processing device is received from the consumer. The credits are decremented based on the received data. The provisioning of a replacement for the consumable to the consumer is coordinated in response to the remaining life of the consumable falling below a threshold and the MPS plan including credits.

In accordance with another aspect of the present application, a system for managing a document processing device of a consumer is provided. The system includes one or more computers. The computers are configured receive a registration request for a managed print service (MPS) plan from a retailer selling the MPS plan to the consumer. The MPS plan includes a plurality of credits. The computers are further configured to associate the MPS plan with an MPS account of the consumer based on the registration request and associate the document processing device with the MPS plan. Even more, the computers are configured to receive data regarding a remaining life of a consumable of the document processing device or usage of the document processing device from the consumer and decrement the credits based on the received data. Moreover, the computers are configured to coordinate the provisioning of a replacement for the consumable to the consumer in response to the remaining life of the consumable falling below a threshold and the MPS plan including available credits.

In accordance with another aspect of the present application, a computer-implemented method for managing a document processing device of a consumer is provided. A software agent is received and a graphical user interface (GUI) is displayed to the consumer using the software agent. The GUI relates variations of one or more parameters of a managed print service (MPS) plan to average printing purchases of the consumer over a predetermined period of time. The MPS plan is updated based on a selected variation of a parameter display. The updated MPS plan is purchased and/or renewed for the document processing device.

### BRIEF DESCRIPTION OF THE DRAWINGS

FIG. 1 illustrates a networked environment for a micro managed print service (MMPS);

FIG. 2 illustrates a document processing device;

FIG. 3 illustrates a graphical representation of the relation between page coverage and page volume using gas gauges;

FIG. 4 illustrates a consumer computer;

FIG. 5 illustrates cancellation of an MMPS plan using a portal of a print service system;

FIG. 6 illustrates a print service computer;

FIG. 7 illustrates a method by which a consumer can register an MMPS plan;

FIG. 8 illustrates a method by which a consumer is provided consumables after registering an MMPS plan; and,

FIG. 9 illustrates a method by which a consumer cancels an MMPS plan.

### DETAILED DESCRIPTION

The present application provides a micro managed print service (MMPS). In one embodiment, a consumer visits a retail store of a retailer and purchases a document processing device, such as a printer. Further, when purchasing the document processing device, the consumer purchases an MMPS plan tailored to the normal printing purchases of the consumer. By purchasing the MMPS plan, the consumer is automatically provided consumables, as necessary, to operate the document processing device during the life of the MMPS plan. In some embodiments, the consumer can also cancel the MMPS plan at any time by paying a buyout price based on, for example, pages used, pages paid for, and supplies shipped.

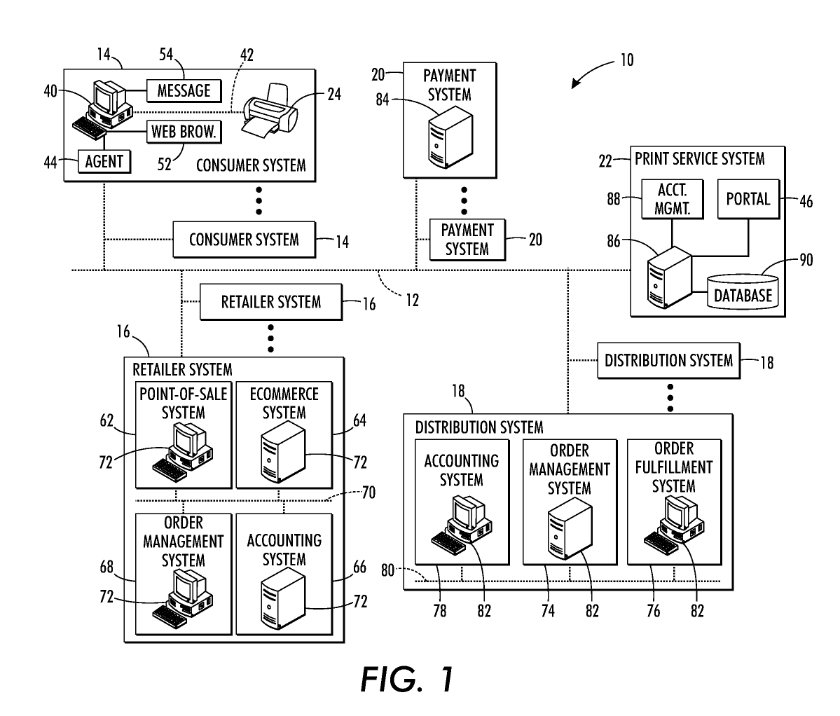

With reference to FIG. 1, a networked environment 10 for the MMPS is provided. The networked environment 10 includes one or more primary communication networks 12, such as the Internet, interconnecting a plurality of systems. The systems include one or more consumer systems 14, one or more retailers 16, one or more distribution systems 18, one or more payment systems 20, and a print service system 22.

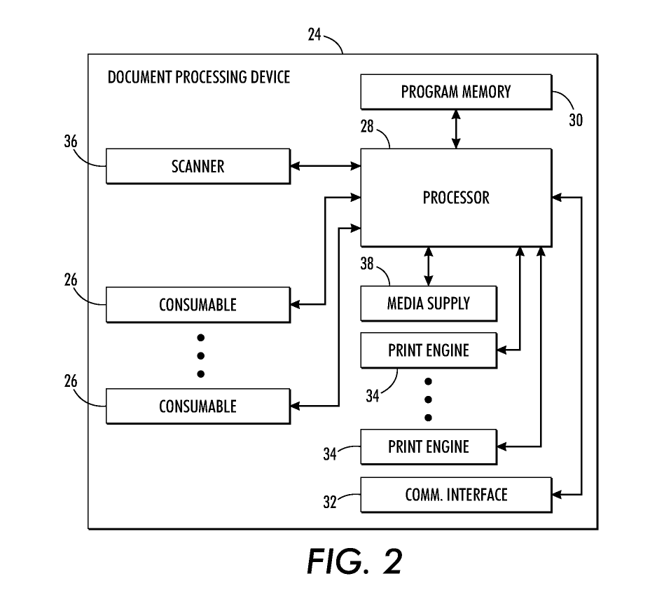

The consumer systems 14 each correspond to a consumer and each include one or more document processing devices 24, such as printers. The document processing devices 24 are typically obtained from a retailer at a storefront of the retailer or by way of an electronic commerce (e-commerce) interface of the retailer. The document processing devices 24 provide document processing functions, such as printing, stapling, and so on. Further, the document processing devices 24 include one or more consumables 26 (see FIG. 2), such as ink, toner, staples, and so on, which are consumed through execution of the document processing functions. The document processing devices 24 can include, for example, one or more of color printers, black and white printers, laser printers, inkjet printers, dot-matrix printers, multifunction printers, and so on.

As illustrated in FIG. 2, each of the document processing devices 24 includes a processor 28 and a program memory 30. The program memory 30 includes processor executable instructions, which are executed by the processor 28, to controllably provide document processing functions. The document processing device 24 further includes a communication interface 32 providing the processor 28 an interface with external devices and/or networks for communicative exchange of data, information, document processing jobs (e.g., print jobs), and so on. In addition, the document processing device 24 includes one or more document processing components or systems, such as one or more print engines 34, a scanner 36, a media supply 38, one or more consumables 26, and so on.

Referring back to FIG. 1, each of the consumer systems 14 further includes one or more computers 40. One or more consumer communication networks 42, such as a local area network (LAN), typically interconnect the computers 40, and the computers 40 are typically connected to the primary communication networks 12. In some embodiments, at least one of the computers 40 is integrated with one of the document processing devices 24. Each of document processing devices 24 is connected to at least one of the computers 40 by a communication link. The communication link can, for example, be one or more consumer data buses, such as a universal serial bus, and/or the consumer communication networks 42.

The computers 40 are configured to monitor the document processing devices 24, and/or perform management tasks for one or more MMPS accounts, of the consumer using a software agent 44. The monitoring and the management tasks are performed over the primary communication networks 12 with the print service system 22, which maintains the MMPS accounts. Each MMPS account is associated with one or more document processing devices 24 and one or more MMPS plans corresponding to the document processing devices 24. Typically, there is a one-to-one correspondence between the MMPS plans and the document processing devices 24. Each of the MMPS plans includes terms and conditions of service and one or more parameters defining the MMPS plan.

The parameters can include, for example, one or more of a mono page price, a color page price, a page quantity, a staple price, a staple quantity, an expiration date, and other like parameters. The parameters can include one or more price schedules relating price and quantity. For example, the parameters can include parameter defining the color page price at different quantities, these parameters collectively defining a price schedule. Typically, the larger the quantity, the lower the per unit price. For example, the greater the quantity of color pages, the lower the color page price. The parameters can further be specified for different types of document processing devices. For example, a document processing device of type A has a first mono page price and a document processing device of type B has a second, different mono page price. Even more, the consumer can set at least some of the parameters, such as parameters pertaining to quantity.

The MMPS account further includes information identifying one or more retailers from which the consumer obtained the MMPS plans. The MMPS plan can further include payment (e.g., credit and/or debit card information, including a debit or credit permanent account number (PAN)) and/or fulfillment information (e.g., cardholder address).

Even more, the MMPS account includes information identifying the remaining lives of the MMPS plans. As noted briefly above, and described in further detail below, during the life of an MMPS plan, the consumer is provided consumables 26 (see FIG. 2) for an associated document processing device, as necessary. As the consumer consumes the consumables 26, the remaining life of the MMPS plan is reduced. The information identifying the remaining life of an MMPS plan can be defined by credits, such as number of pages or money.

As the consumer uses the consumables 26, the credits are decremented. For example, when the consumer prints a page, the credits, if defined in terms of pages, are decremented by 1. If the credits are not defined in terms of pages, a conversion between the unit of the credits and pages is performed. When the consumer obtains an MMPS plan, the consumer obtains a predetermined amount of credits, such as pages. Further, when the MMPS plan is renewed, the available credits are incremented. For example, if the MMPS plan was for 100 credits in terms of pages, and it is renewed after using 80 pages and without modification of the MMPS plan, the consumer will have 120 pages upon renewal.

To obtain an MMPS account, the consumer typically visits a storefront or e-commerce interface, such as a website, of a retailer selling MMPS plans. As discussed hereafter, the retailer partners with a provider of the print service system 22 and typically works out an agreement discussing how profit from the MMPS plans are shared between the two parties. At the storefront or e-commerce interface of the retailer, the consumer can obtain information regarding the benefits of MMPS plans. For example, a sales associate at the storefront can provide the consumer with information regarding the benefits of the MMPS plans. The retailer from which the consumer obtains the MMPS plans can brand the software agent 44. For example, the retailer can place their logo, select color pallet, etc. on the software agent 44.

After deciding to obtain an MMPS plan, the MMPS plan is registered to the consumer. Registration of the MMPS results includes association of the MMPS plan to an MMPS account. The MMPS plan can be associated with an existing MMPS account of the consumer or associated with a new MMPS account. The retailer performs this association. For example, the retailer connects to a portal 46, such as a web portal, of the print service system 22. From there, the retailer creates an MMPS account and/or locates an existing MMPS account. The retailer then associates the MMPS plan to the MMPS account. Typically, the retailer only performs the association of the MMPS plan to the MMPS account on the condition that the consumer purchases a document processing device for the MMPS plan from the retailer and/or on the condition that the consumer purchases the MMPS plan from the retailer.

After the retailer makes the association between the MMPS plan and the MMPS account, the consumer associates the MMPS plan to a document processing device over the primary communication networks 12 using the software agent 44. Typically, this is performed in accordance with instructions provided to the consumer in an electronic message, such as an email, from the print service system 22. The software agent 44 can be, and is typically, branded by the retailer. The consumer can further pay for the MMPS plan using the software agent 44.

The software agent 44 monitors the document processing devices 24 of the consumer. The monitoring includes determining the state of the consumables 26 (see FIG. 2) of the document processing devices 24 and/or the usage of the document processing devices 24. Based on the determinations, the remaining lives of the MMPS plans of the document processing devices 24 are updated over the primary communication networks 12. For example, the credits of an MMPS plan associated with a document processing device can be decremented as the document processing device prints. The monitoring can further include determining the remaining lives of the MMPS plans of the document processing devices 24 over the primary communication networks 12 and disabling any document processing devices 24 associated with MMPS plans which reach the end-of-life.

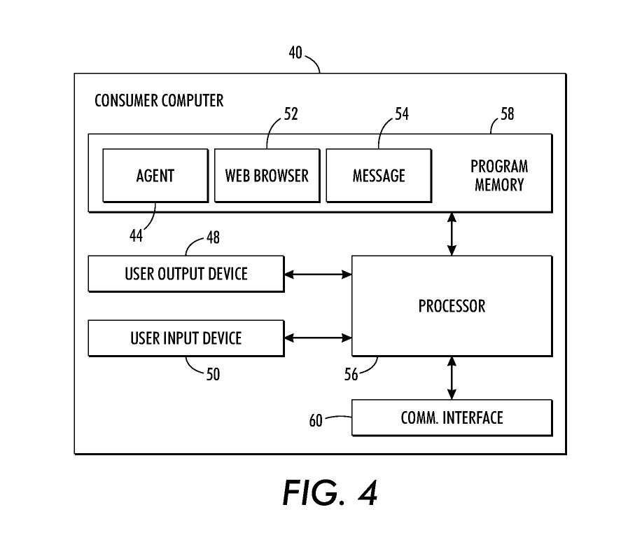

The software agent 44 can further perform one or more management tasks for the MMPS accounts of the consumer. Performance of management tasks for the MMPS accounts typically includes presenting the consumer with a graphical user interface, such as the portal 46, using a user output device 48 of the computers 40 (see FIG. 4). The consumer can then interact with the graphical user interface with a user input device 50 of the computers 40 (see FIG. 4). Further, management tasks are typically performed over the primary communication network 12 since the print service system 22 maintains the MMPS accounts.

According to one management task, the software agent 44 allows the consumer to enter and/or otherwise update account information of the MMPS accounts over the primary communication networks 12. Account information can include, for example, payment information, fulfillment information parameters of the MMPS plans, and so on. As to the parameters of the MMPS plans, the consumer is typically limited as to what they can enter and/or update. For example, in some embodiments, the consumer can only update parameters pertaining to quantity or other parameters affecting credits, but not parameters pertaining to price or expiration. Further, the parameters of an MMPS plan can typically only be updated upon renewing the MMPS plan.

According to another management task, the software agent 44 allows the consumer to associate an MMPS plan with printing supply purchases. For example, the software agent 44 displays a graphical representation relating page coverage, such as how many pages the MMPS plan will yield, with page volume, such as monthly page volume. As another example, the software agent can display a graphical representation of the savings between different purchase amounts and/or page quantities. Typically, per unit price of consumables is reduced as quantity is increased. These graphical representations allow the consumer to determine parameters of the MMPS plan, such as quantity.

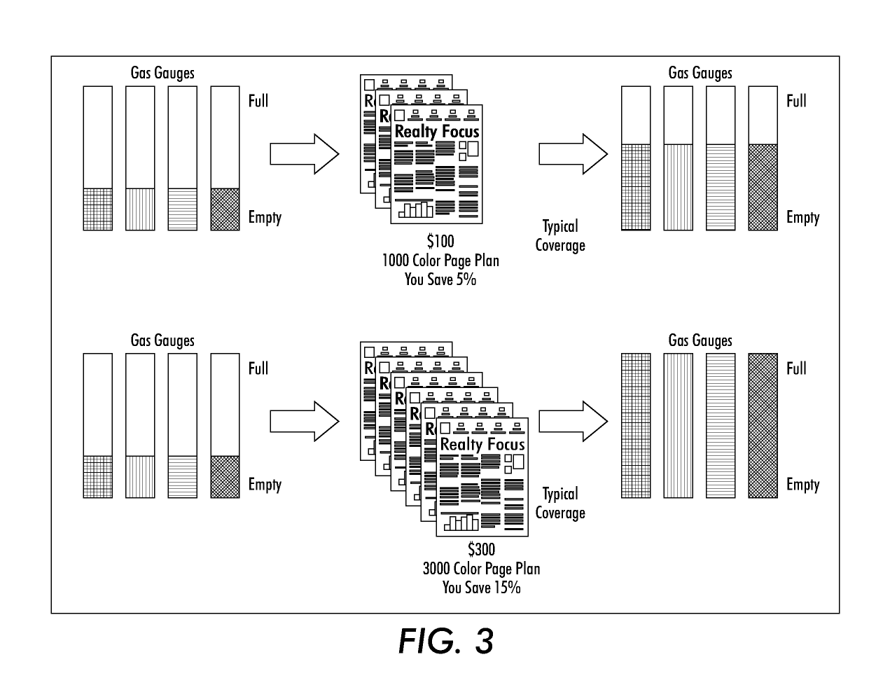

As illustrated in FIG. 3, gas gauges are used to convey the relationship between page volume and page coverage, as well as the savings between different purchase amounts and page quantities. The left most gas gauges show the remaining page coverage of the MMPS plan as remaining fuel, and the right most gas gauges show the remaining page coverage of the MMPS plan after a renewal of the MMPS plan for 1000 pages and 3000 pages.

According to another management task, the software agent 44 displays a buyout price for an MMPS plan to the consumer and allows the consumer to buyout the MMPS plan. The buyout price is the price the consumer must pay to terminate the MMPS plan. Insofar as the consumer wishes to buyout the MMPS plan, for example, by selecting a displayed termination button, the software agent 44 notifies the print service system 22 and the consumer is billed for the buyout price.

According to another management task, the software agent 44 allows the consumer to associate an MMPS plan with one or more document processing devices. Typically, however, only one document processing device can be associated with an MMPS plan. For example, a list of the unassociated document processing devices and a list of unassociated MMPS plans can be displayed to the consumer. The consumer can then select the document processing device and the MMPS plan to associate.

As noted above, the monitoring and the management tasks are performed over the primary communication networks 12 with the print service system 22, which maintains MMPS accounts. Hence, the software agent 22 further allows communication, typically authorized, secure, encrypted communication, with the print service system 22 over the primary communication networks 12. In some embodiments, this communication with the print service system 22 is performed through the portal 46 of the print service system 22. For example, if the portal is a web portal, the software agent 22 can include and/or otherwise make use of a web browser to access the portal 46.

The computers 40 can also be configured for web browsing and/or electronic messaging using a web browser 52 and/or a message program 54, such as an email program. The web browser 52 presents the consumer with a graphical user interface of a website, such as a website of a retailer or the provider of the print service system 22, typically received over the primary communication networks 12, using the user output device 48 (see FIG. 4). The message program 54 allows the receipt of messages over the primary communication networks 12 and presentation of the received messages on a graphical user interface using the user output device 48 (see FIG. 4). The consumer can then interact with the web browser 52 and/or the message program 54 using the user input device 50 (see FIG. 4).

As illustrated in FIG. 4, each of the computers 40 includes at least one processor 56 executing processor executable instructions of a program memory 58 which implement the functionality of the computer 40. For example, the processor executable instructions can include processor executable instructions embodying one or more of the software agent 44, the web browser 52 and the message program 54.

Further, the computer 40 includes one or more communication interfaces 60 to allow the computer to interface and communicate with one or more of the primary communication networks 12, the consumer communication networks 42 and/or the consumer data buses. In some embodiments, a user output device 48, such as a display device, and a user input device 50, such as a mouse or keyboard, of the computer 40 allow a user to interact with the computer 40. For example, the user output device 48 allows the presentation of a user interface to the consumer, and the user input device 50 allows the consumer to interact with the user interface.

Referring back to FIG. 1, the retailer systems 16 each correspond to a retailer selling one or more MMPS plans and/or one or more document processing devices to the consumers. Each of the MMPS plans and/or the documents processing devices are typically associated with stock-keeping units (SKUs) of the retailer. The retailers typically include storefronts and/or e-commerce interfaces and are registered with the print service system 22 to sell the MMPS plans. Registration is typically performed through the portal 46 of the print service system 22. For example, a representative of the provider of the print service system 22 can access the portal 46 and create the retail account based on information provided by the retailer. As another example, the retailer can access the portal 46 and sign up for the retail account through the portal 46.

Each of the retailer systems 16 includes one or more subsystems, the subsystems including a point-of-sale system 62, an e-commerce system 64, an accounting system 66 and an order management system 68. One or more retailer communication networks 70, such as a LAN, typically interconnect the subsystems. Further, the subsystems can be combined in any number of combinations. For example, the order management system 68 and the accounting system 66 can be combined into a common system.

The point-of-sale system 62 and the e-commerce system 64 are each configured to collect transaction information from consumers to complete transactions between the retailer and the consumers. Each transaction is for the sale of one or more products and/or services, such as a document processing device and/or an MMPS plan, to one of the consumers. The transaction information includes order information and payment information. The order information for a transaction includes information identifying the products and/or services being sold to the consumer. The payment information for a transaction includes information identifying a payment instrument, such as a credit or debit card. The transaction information can also include fulfillment information identifying, for example, a shipping address.

In contrast with the e-commerce system 64, the point-of-sale system 62 collects the transaction information at a storefront of the retailer. For example, a sales associate of the retailer enters the order information by scanning bar codes of the products and/or services, and the consumer enters the payment information by swiping their payment instrument, such as a credit or debit card. On the other hand, the e-commerce system 64 collects the transaction information electronically, typically over the primary communication networks 12. After collecting the transaction information for a transaction, the point-of-sale system 62 or the e-commerce system 64 typically sends transaction information to the order management system 68 and/or one of the payment systems 20 to complete the transaction.

The point-of-sale system 62 and/or the e-commerce system 64 are typically configured to access the print service system 22 over the primary communication networks 12 and begin registration of consumers with MMPS plans. A software program of the systems 62, 64 allows communication, typically authorized, secure, encrypted communication, with the print service system over the primary communication networks 12. Typically, the systems 62, 64 access the print service system 22 through the portal 46 of the print service system 22. For example, the systems 62, 64 can use a web browser to access the portal 46 when the portal 46 is a web portal. Other systems, such as the order management system 68 and/or components, such as computers, of the retailer system 16 can additionally or alternatively be configured to begin registration of consumers with MMPS plans.

The order management system 68 is configured to receive and store transaction information from, for example, the e-commerce system 64 and/or the point-of-sale system 62. Further, based on the transaction information for a transaction, the order management system 68 typically completes the transaction, including submitting fulfillment information to one of the distribution systems 18, and/or submitting payment information to one of the payment systems 20, over the primary communication networks 12 to complete the transaction. Fulfillment is typically only necessary for e-commerce transactions, since point-of-sale transactions are typically fulfilled at the time of sale.

The accounting system 66 is configured to record and process accounting transactions, such as transactions pertaining to accounts payable and accounts receivable. In some embodiments, the accounting system can coordinate with the order management system 68 to determine accounts receivable and, optionally, generate invoices for consumers. The accounting system 66 can further be configured to generate reports, such as a profit and/or loss report, an accounts receivable report, and an accounts payable report. Moreover, the accounting system 66 can be configured for settlement with the print service system 22, since profits from the MMPS plans are typically shared with the print service system 22.

Each of the subsystems of the retailer system 16 includes one or more computers 72, typically interconnected by the retailer communication networks 70. The computers 72 of the subsystems are configured to perform the respective functionality of the subsystems. Each of the computers 72 includes at least one processor executing processor executable instructions of a program memory which implement the functionality of the computer. One or more communication interfaces allow the computer to interface and communicate with the retailer communication networks 70 and/or the primary communication networks 12. Further, in some embodiments, a user output device, such as a display device, and a user input device, such as a mouse or keyboard, of the computer allow a user to interact with the computer.

The distribution systems 18 each correspond to a distributor. The distribution systems 18 fulfill orders for consumables of MMPS plans. Each of the distribution systems 18 includes one or more subsystems, the subsystems including an order management system 74, an order fulfillment system 76, and an accounting system 78. One or more distributor communication networks 80, such as a LAN, typically interconnect the subsystems. Further, the subsystems can be combined in any number of combinations. For example, the accounting system 78 and the order management system 74 can be combined.

The order management system 74 is configured to receive and store transaction information from the print service system 22 and/or the retailer systems 16. The transaction information is typically received over the primary communications networks 12 and includes order information for products, such as document processing devices and/or consumables. The transaction information can further include payment information and/or fulfillment information. The payment information typically identifies the party to bill and how to bill the party. The party to bill is typically the retailer corresponding to the transaction. The fulfillment information includes, for example, a shipping address, typically corresponding to a consumer.

The order management system 74 can further be configured to provide the status of transactions, such as shipping status, over the primary communications networks 12 to, for example, the print service system 22. Also, the order management system 74 can be configured to submit payment information for transactions to the payment systems 20 over the primary communication networks 12 to bill for and complete the transactions.

The order fulfillment system 76 is configured to fulfill pending orders maintained by the order management system 74. For example, the order fulfillment system 76, for each of the open orders maintained by the order management system 74, determines fulfillment information, such as delivery address, and automatically and/or manually ships the order based on the fulfillment information. As to the latter, the fulfillment information can be displayed to a user of the order fulfillment system 76 (e.g., a user working in a warehouse).

The accounting system 78 is configured to track accounts receivable for fulfilled orders. This can be performed through coordination with the order management system 74. Further, the accounting system 76 typically bills for open accounts receivable. Billing can include generating and shipping invoices. As should be appreciated, the invoices are typically generated for the retailers, not the consumers. Alternatively, billing can include submitting payment information for each transaction to one of the payment systems 20 over the primary communication networks 12.

Each of the subsystems of the distribution system 18 includes one or more computers 82, typically interconnected by the distributor communication networks 80. The computers 82 of the subsystems are configured to perform the respective functionality of the subsystems. Each of the computers 82 includes at least one processor executing processor executable instructions of a program memory which implement the functionality of the computer. One or more communication interfaces allow the computer to interface and communicate with the retailer communication networks 80 and/or the primary communication networks 12. Further, in some embodiments, a user output device, such as a display device, and a user input device, such as a mouse or keyboard, of the computer allow a user to interact with the computer.

The payment systems 20 are each associated with a party to process payments for the retailors and are, for example, payment processors. Each of the distribution systems 20 includes one or more computers 84 configured to receive payment information over the primary communication networks 12 and process payments using the payment information. The computers 84 are typically interconnected with one or more payment communication networks, such as a LAN, and each of the computers includes at least one processor executing processor executable instructions of a program memory which implement the functionality of the computer. One or more communication interfaces allow the computer to interface and communicate with the payment communication networks and/or the primary communication networks 12.

The print service system 22 is associated with a party to manage the MMPS accounts, as well as coordinate fulfillment and financial transactions with the consumers to meet their printing needs. The print service system 22 includes one or more computers 86 configured to perform management the MMPS using an account management program 88. The computers 86 are typically interconnected with one or more print service communication networks, such as a LAN.

The account management program 88 maintains retailer accounts for each of the retailers in one or more databases 90 of the print service system 22. Each retailer account includes terms and conditions agreed to by the retailer and the provider of the printer service system 22. The terms and conditions typically define how profit from MMPS plans is shared between the provider and the retailer. The retailer account can further include one or more user accounts, each including login credentials, to authenticate, for example, administrators and/or sales associates of the retailer. Moreover, the retailer account can include the requisite detail to allow the print service system 22 to interface with the distribution systems 18.

The retailer account can further include one or more different MMPS plans defined by the retailer. Each of the MMPS plans includes terms and conditions which are displayed to the consumer during registration and which the consumers must agree to. Further, each of the MMPS plans includes one or more parameters, including, for example, one or more of a mono page price, a color page price, a page quantity, a staple price, a staple quantity, an expiration date, and other like parameters. These MMPS plans can serve as templates for the MMPS plans of the MMPS accounts.

The parameters can include one or more price schedules relating price and quantity. For example, the parameters can include parameter defining the color page price at different quantities, these parameters collectively defining a price schedule. Typically, the larger the quantity purchased, the lower the per unit price. For example, the greater the quantity of color pages, the lower the color page price. The parameters can further be specified for different types of document processing devices. For example, a document processing device of type A has a first mono page price and a document processing device of type B has a second, different mono page price. Even more, the consumer can set at least some of the parameters, such as parameters pertaining to quantity.

The account management program 88 further maintains MMPS accounts for the consumers in the databases 90 of the print service system 22. Each MMPS account identifies one or more retailers with which it is associated with. Further, the MMPS account identifies one or more document processing devices with which it is associated and identifies one or more MMPS plans of the retailers with which the document processing devices are associated. For each MMPS plan, the MMPS account identifies terms and conditions of service and one or more parameters defining the MMPS plan. The parameter can include, for example, one or more of a mono page price, a color page price, a page quantity, a staple price, a staple quantity, an expiration date, and other like parameters.

The MMPS account further includes information identifying one or more retailers from which the consumer obtained the MMPS plans. The MMPS plan can further include payment (e.g., credit and/or debit card information, including a debit or credit permanent account number (PAN)) and/or fulfillment information (e.g., cardholder address).

Even more, the MMPS account includes information identifying the remaining lives of the MMPS plans. The information identifying the remaining life of an MMPS plan can by defined by credits, such as number of pages or money. As the consumer uses the consumables 26 (see FIG. 2), the credits are decremented. When the consumer obtains an MMPS plan, the consumer obtains a predetermined amount of credits, such as pages. Further, when the MMPS plan is renewed, the available credits are incremented. Even more, the MMPS accounts include information identifying the states of consumables of the document processing devices. The software agents 44 of the consumer systems 14 update the states of the consumables. Moreover, the MMPS account can include authentication credentials.

The account management program 88 further receives account information to update the databases 90 and/or provides account information maintained in the databases 90. The information is typically communicated over the primary communications networks 12, but it can be communicated in other ways. For example, a user input device of the computers 86 can be used to received information, and a user output device of the computers 86 can be used to provide information. Where the information is communicated over the primary communications network 12, the information can be communicated wholly or partially through the portal 46 of the print service system 22, such as a web portal. Further, the information is typically only communicated to authenticated users.

Received accounting information can include information regarding the status of consumables and/or usage of document processing devices. This information is typically received from the software agent 44 and is used to update the remaining lives of the corresponding MMPS plans and to determine when to provide the corresponding consumer with additional consumables. For example, credits of an MMPS plan are decremented as a corresponding document processing device is used.

If the remaining life of an MMPS plan falls below a configurable, predetermined level (e.g., less than 10% of the previously purchased credits), the account management program 88 can automatically renew the MMPS plan. As noted above, certain parameters of the MMPS plan can be varied, such as quantity, when renewing. These modifications do not take effect until renewal. For example, the consumer can increase the page quantity of an MMPS plan, which typically reduces the per page price. Upon renewal, the consumer obtains the reduced per page price. In renewing the MMPS plan, the consumer is automatically billed using payment information associated with the MMPS account of the consumer. This includes submitting the payment information to the payment systems 20, which causes funds to be transferred to the retailer and/or the provider of the print service system 22. Further, the accounting system 66 of the retailer is notified of the renewal. Since the print service system 22 and the retailer share revenue generated from the MMPS plan, reconciliation may be necessary between the retailer and the provider.

If the remaining life of a consumable falls below a predetermined level during the life of a corresponding MMPS plan, the account management program 88 prompts one of the distributors to provide the consumer with replacement consumables. For example, using distributor information associated with the retailers account, a request is submit to the order management system 74 of the distributor for replacement consumables. The request indicates that the replacement consumables are to be shipped to the consumer using fulfillment information of the MMPS account. The account management program 88 monitors the status of the order and/or is otherwise notified of fulfillment.

Received account information can further include information to register an MMPS plan to a consumer and/or create an MMPS account. As noted above, registration of the MMPS results in association of the MMPS plan to an MMPS account. The MMPS plan can be associated with an existing MMPS account of the consumer or associated with a new MMPS account. Where an MMPS account exists, the information includes information to identify the existing MMPS account. Otherwise, the information includes information create a new MMPS account. Typically, the retailer from which the consumer purchased the MMPS plan performs association. Further, the retailer typically begins account creation using, for example, an email address of the consumer. The consumer then completes the account creation by, for example, providing the print service system 22 with payment information and/or fulfillment information.

Received account information can further include information to create retailer accounts. This information is typically received from, for example, the portal 46. For example, a retailer desiring to participate in the MMPS navigates to the portal 46 and provides all the necessary account information, discussed above, to create a retailer account.

The received account information can further include information to update MMPS accounts and/or retailer accounts. Account information to update accounts can be received from, for example, the portal 46 and/or the software agent 44. For example, a consumer can change a fulfillment address through a graphical user interface presented by the software agent 44. As another example, a consumer can change the quantity of an MMPS plan through the portal 46.

Provided account information can include buyout prices for MMPS plans. A buyout price for an MMPS plan is the price a consumer must pay to cancel the MMPS plan. The buyout price takes into account one or more of actual prints, supplies shipped, partially consumed supplies, contract penalties or any other program requirements that need to be enforced. Further, the buyout price can be automatically determined based on the MMPS account of the consumer.

If the consumer selects to cancel the MMPS plan, the consumer is automatically billed the buyout price using, for example, the payment information associated with the MMPS account of the consumer. This includes submitting the payment information to the payment systems 20, which causes funds to be transferred to the retailer and/or the provider of the print service system 22. Further, the accounting system 66 of the retailer is notified of the cancellation. Since the provider of the print service system 22 and the retailer share revenue generated from the MMPS plan, reconciliation may be necessary between the retailer and the provider.

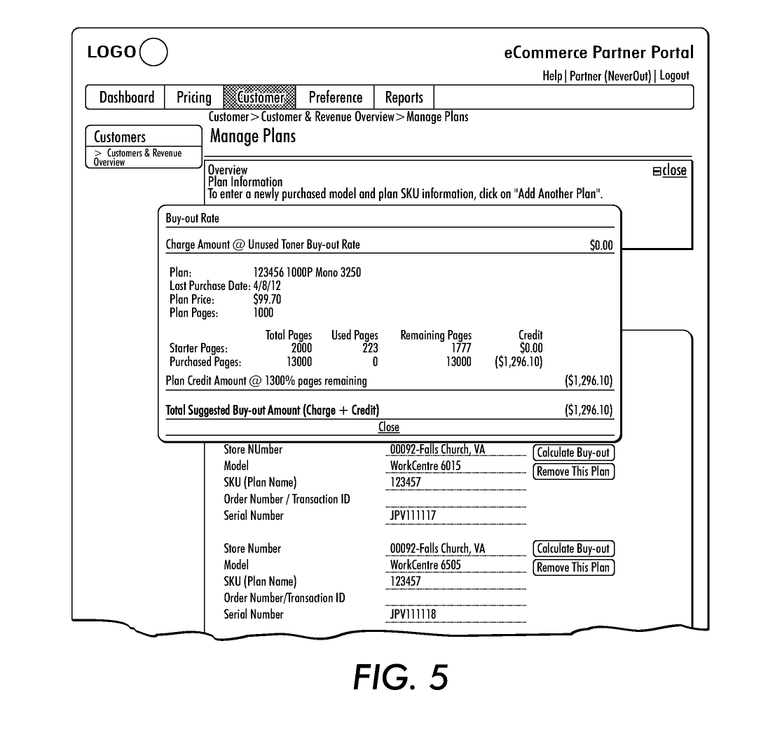

As illustrated in FIG. 5, the portal 46 can be used to cancel an MMPS plan. The portal 46 shows the user the actual cost to “buy-out” of the MMPS plan. A representative of the retailer can access the portal 46, which relays the buyout price to the consumer, for example, over the phone. Alternatively, the consumer can access the portal 46. A single acknowledge from the user can then cancel the MMPS plan, thereby excluding the consumer for receiving additional consumables (supplies) in connection with the MMPS plan.

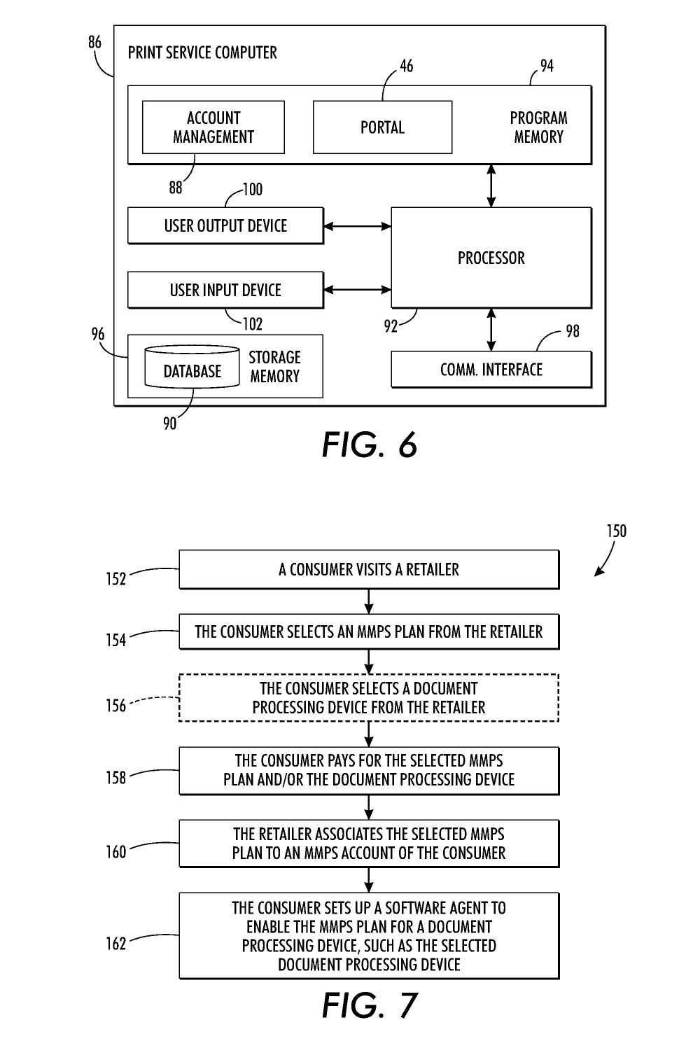

As illustrated in FIG. 6, each of the computers 86 includes at least one processor 92 executing processor executable instructions of a program memory 94 which implement the functionality of the computer. For example, the processor executable instructions can include processor executable instructions embodying at least a portion of the account management program 88 and/or at least a portion of the portal 46. In that regard, the account management program 88 can be distributed across the computers 86.

Further, the computer includes one or more storage memories 96 for the databases 90 and one or more communication interfaces 98 to allow the computer to interface and communicate with one or more of the primary communication networks 12 and the print service communication networks. In some embodiments, a user output device 100, such as a display device, and a user input device 102, such as a mouse or keyboard, of the computer allow a user to interact with the computer.

While the foregoing systems, such as the consumers systems 14 and the print service system 22, were discretely described, it is to be appreciated that the systems can be combined in any combinations and parties can take on multiple roles. For example, the party providing the retail service system 22 can also be a retailer. Further, while not described above, the system of account credits and print units described in U.S. patent application Ser. No. 12/696,892 for METHODS AND APPARATUS FOR MANAGING PRE-PAID PRINTING SYSTEM ACCOUNTS and U.S. patent application Ser. No. 12/696,076 for METHODS AND APPARATUS FOR MANAGING CREDIT CARD USAGE IN PRE-PAID PRINTING SYSTEM ACCOUNTS can be applied to the MMPS plans. For example, the parameters of an MMPS plan can include parameters for converting between account credits and print units, and the remaining life of the MMPS plan can be defined by the remaining account credits.

With reference to FIG. 7, a method 150 by which a consumer can register an MMPS plan is illustrated. The method 150 is suitably performed through use of the systems described in connection with FIG. 1. The method 150 begins when the consumer visits 152 one of the retailers to buy the MMPS plan from the retailer. Typically, the consumer visits the retailer at a storefront. At the storefront, a sales associate can provide the consumer with information regarding the benefits of the MMPS. Alternatively, the consumer can visit the retailer at an e-commerce interface, such as a web site, of the retailer using, for example, the consumer system 14 of the consumer. The e-commerce interface can present information regarding the benefits of the MMPS. Typically, each MMPS plans is associated with a different SKU of the retailer.

To buy the MMPS plan, the consumer selects 154 an MMPS plan from one or more MMPS plans offered by the retailer, for example, based on the SKU of the selected MMPS plan. In some embodiments, the consumer further selects 156 a document processing device to buy with the selected MMPS plan. This selection is collected by the retailer system 16 of the retailer. Thereafter, the consumer pays 158 for the selected MMPS plan and, in some embodiments, the selected document processing device. This includes collecting payment information, such as a credit or debit card PAN, by the retailer system 16 and submitting the payment information to the payment systems 20 by the retailer system 16 to complete the transaction.

After the consumer pays, the retailer associates 160 the purchased MMPS plan to an existing or new MMPS account of the consumer. To create an account, the retailer collects at least information to contact the consumer, such as an email address. Further, the retailer can add the payment information used to pay for the MMPS plan to the account and/or, in some embodiments, associate the purchased document processing device to the MMPS plan. Other information that can be collected from the consumer, and added to the MMPS account, includes, for example, fulfillment information. An existing MMPS account can be looked up by unique, identifying information for the consumer, such as an email address or unique account identifier (e.g., loyalty account). Further, the retailer can verify and/or update existing account information.

When the consumer purchases the MMPS plan at a storefront, a sales associate of the retailer typically associates the MMPS plan. For example, the sales associate of the retailer connects to the portal 46 of the print service system 22 and performs the association. When the consumer purchases the MMPS plan through the e-commerce interface, the e-commerce interface suitably collects the necessary information to make the association directly from the consumer.

After the association between the MMPS account and the MMPS plan is made, the consumer sets up 162 the software agent 44, typically branded by the retailer, to complete enablement of the MMPS plan. Typically, the consumer typically receives a message from the print service system 22 with instructions to complete enablement of the MMPS plan. For example, an electronic message, such as an email message, can be sent to the consumer, such that the message is awaiting them when they return to their fulfillment destination for the MMPS plan, such as their home or place of business. The instructions to complete enablement of the MMPS plan instruct the consumer to download and/or install the software agent 44 on their computers 44.

During setup of the software agent 44, a document processing device is discovered and associated with the MMPS plan if not already done. For example, the software agent 44 looks to the consumer data buses and/or the consumer communication networks 42. Further, the consumer can enter any additional information needed by the MMPS account. Typically, this includes payment and fulfillment information. The payment information is needed to renew the MMPS plan, and the fulfillment information is needed to supply the consumables to the consumer. Even more, the consumer reviews and acknowledge the terms and conditions of the MMPS plan.

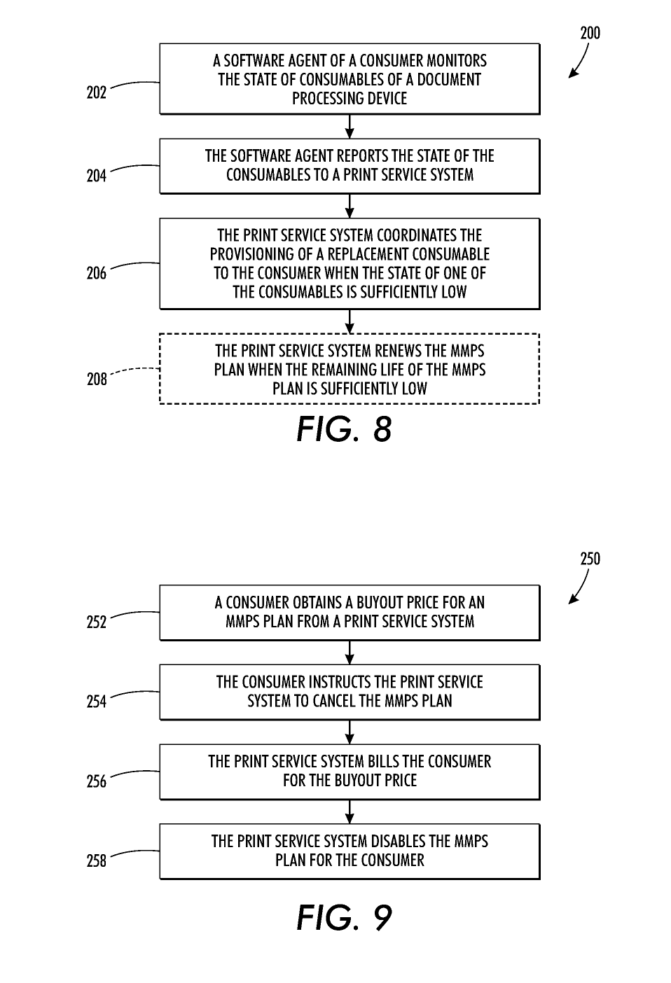

With reference to FIG. 8, a method 200 by which a consumer is provided consumables after registering an MMPS plan is illustrated. The method 200 is suitably performed through use of the systems described in connection with FIG. 1. The software agent 44 monitors 202 the states of consumables of an associated document processing device and reports 204 the state of the consumables to the print service system 22 and/or otherwise updates the remaining life of the MMPS plan on the print service system 22.

When the state of consumables of the document processing device gets sufficiently low (e.g., ink level of an ink cartridge falls below a predetermined level), the print service system coordinates 206 the provisioning of replacement consumables. This includes submitting an order to one of the distribution systems 18 to provide replacement consumables, typically using distribution information of the retailer associated with the MMPS plan. The distribution system 18 then ships the replacement consumables to the consumer at the fulfillment address of the consumer. Further, the distribution system 18 typically bills the retailer associated with the MMPS plan, but the distribution service system 18 can alternatively bill the provider of the print service system 22, which bills the retailer associated with the MMPS plan.

When the remaining life of the MMPS plan gets sufficiently low (e.g., less than 10% of the originally purchased page counts), the print service system 22 typically renews 208 the MMPS plan automatically. This includes submitting the payment information of the MMPS account associated with the MMPS plan to one of the payment systems 20 to bill the consumer. Further, the retailer associated with the MMPS plan is notified of the renewal. Typically, this is because the provider of the print service system 22 and the retailer associated with the MMPS plan share revenue generated from the MMPS plan. The notification allows the retailer to settle with the provider of the print service system 22. Even more, the MMPS account associated with the MMPS plan is updated to reflect the renewal (e.g., the remaining life is increased).

With reference to FIG. 9, a method 250 by which a consumer cancels an MMPS plan is provided. The method 250 is suitably performed through use of the systems described in connection with FIG. 1. Exiting a managed print service program can be a labor-intensive process to account for actual printing volume, the supplies that have been shipped and enforcement of any contractual penalties. The method 250 allows fully automated cancellation of the MMPS plan since the print service system through use of the systems 22 contains all the needed information to automatically perform the accounting reconciliation of actual prints, supplies shipped, contract penalties or any other program requirements that need to be enforced.

To cancel an MMPS plan, the consumer directly or indirectly accesses the print service system 22 to obtain 252 a buyout price. As to the former, the consumer can access the print service system 22 by way of the portal 46 (e.g., using a web browser) and/or using the software agent 44. As to the latter, the consumer can contact a representative of the retailer associated with the MMPS plan or the provider of the print service system 22. The representative can then directly access the print service system 22, for example, using the portal 46 of the print service system 22.

As discussed above, the buyout price is the price the consumer must pay to cancel the MMPS plan. It takes into account one or more of actual prints, supplies shipped, partially consumed supplies, contract penalties or any other program requirements that need to be enforced. Insofar as the consumer agrees to the buyout price, the print service system 22 is directly or indirectly instructed 254 to cancel the MMPS plan. For example, the representative instructs the print service system 22 to cancel the MMPS plan. As another example, the consumer selects a cancellation button on a graphical user interface presented by the software agent 44 or a web browser accessing the portal 46.

In response to the instructions to cancel the MMPS plan, the print service system 22 submits the payment information of the MMPS account associated with the MMPS plan to one of the payment systems 20 to bill 256 the consumer for the buyout price. Further, the MMPS plan disables 258 the MMPS plan for the consumer. The consumer is excluded from the receiving additional consumables per the MMPS plan. Even more, the retailer associated with the MMPS plan is notified. The notification allows the retailer associated with the MMPS plan to reconcile any money owed to or by the party providing the print service system 22, since the retailer associated with the MMPS plan the party providing the printer service system 22 share profit from the MMPS plan.

In view of the foregoing, it is to be appreciated that the present application provides a platform integrating document processing devices, distributors for fulfillment and retailers of printing hardware and services to meet the needs of their consumers. Advantageously, the platform allows consumers the ability to self-manage their MMPS account. Further, the platform advantageously does not require intervention of the retailers after the consumers are initially registered.

Exiting a managed print service can be a labor-intensive process to account for actual printing volume, the supplies that have been shipped and enforcement of any contractual penalties. As described above, the platform advantageously allows consumers to exit the MMPS at any time in an automated way. All the necessary information for account reconciliation is available to the print service system 22.

As used herein, a memory includes one or more of a non-transient computer readable medium; a magnetic disk or other magnetic storage medium; an optical disk or other optical storage medium; a random access memory (RAM), read-only memory (ROM), or other electronic memory device or chip or set of operatively interconnected chips; an Internet/Intranet server from which the stored instructions may be retrieved via the Internet/Intranet or a local area network; or so forth. Further, as used herein, a processor includes one or more of a microprocessor, a microcontroller, a graphic processing unit (GPU), an application-specific integrated circuit (ASIC), an FPGA, and the like; a controller includes: (1) a processor and a memory, the processor executing computer executable instructions on the memory embodying the functionality of the controller; or (2) analog and/or digital hardware; a user input device includes one or more of a mouse, a keyboard, a touch screen display, one or more buttons, one or more switches, one or more toggles, voice recognition engines, and the like; a database includes one or more memories; and a display device includes one or more of a LCD display, an LED display, a plasma display, a projection display, a touch screen display, and the like.

The invention has been described with reference to the preferred embodiments. Modifications and alterations may occur to others upon reading and understanding the preceding detailed description. It is intended that the invention be construed as including all such modifications and alterations insofar as they come within the scope of the appended claims or the equivalents thereof.

What is claimed is:

1. A computer-implemented method for managing a document processing device of a consumer, said method comprising:
associating by at least one computer one or more managed print service (MPS) template plans with an account of a retailer, each of the one or more MPS template plans including a plurality of credits;
receiving by the at least one computer a registration request for an MPS plan from the retailer, the retailer selling the MPS plan to the consumer, and the MPS plan being an instance of one of the MPS template plans;
associating by the at least one computer the MPS plan sold to the consumer with an MPS account of the consumer in response to the registration request;
associating by the at least one computer the document processing device with the MPS plan;
receiving by the at least one computer data regarding a remaining life of a consumable of the document processing device or usage of the document processing device from the consumer;
decrementing by the at least one computer the credits based on the received data; and,
coordinating by the at least one computer the provisioning of a replacement for the consumable to the consumer in response to the remaining life of the consumable falling below a threshold and the MPS plan including credits.

2. The method according to claim 1, wherein the MPS plan includes a plurality of parameters, the plurality of parameters including one or more of page price, page quantity, staple price, staple quantity, expiration date.

3. (canceled)

4. The method according to claim 2, wherein the parameters define a price schedule relating page price and page quantity, the price schedule including page price for a plurality of different page quantities.

5. (canceled)

6. The method according to claim 1, further comprising:
messaging the consumer with instructions to enable the associated MPS plan before receiving the data.

7. The method according to claim 1, further comprising:
renewing the MPS plan in response to the credits falling below a threshold.

8. The method according to claim 7, wherein the renewing includes:
billing the consumer for renewal of the MPS plan, the renewed MPS plan including a predetermined number of credits; and,
incrementing the credits by the predetermined number of credits.

9. The method according to claim 1, further comprising:
automatically determining a buyout price for the MPS plan based on the received data;
billing the consumer the buyout price; and,
disabling the MPS plan.

10. The method according to claim 9, wherein the buyout price is based on one or more of credits, supplies shipped, partially consumed supplies, and terms and conditions of the MPS plan.

11. (canceled)

12. The system according to claim 15, wherein the MPS plan includes a plurality of parameters, the plurality of parameters including one or more of page price, page quantity, staple price, staple quantity, expiration date.

13. The system according to claim 15, wherein the computer is further configured to:
renew the MPS plan in response the credits falling below a threshold.

14. The system according to claim 13, wherein the renewing includes:
billing the consumer for renewal of the MPS plan, the renewed MPS plan including a predetermined number of credits; and,
incrementing the credits by the predetermined number of credits.

15. A system for managing a document processing device of a consumer, said system comprising:
one or more computers configured to:
receive a registration request for a managed print service (MPS) plan from a retailer selling the MPS plan to the consumer, the MPS plan including a plurality of credits;
associate the MPS plan with an MPS account of the consumer based on the registration request;
associate the document processing device with the MPS plan;
receive data regarding a remaining life of a consumable of the document processing device or usage of the document processing device from the consumer;
decrement the credits based on the received data;
coordinate the provisioning of a replacement for the consumable to the consumer in response to the remaining life of the consumable falling below a threshold and the MPS plan including available credits;
automatically determine a buyout price for the MPS plan based on the received data;
bill the consumer the buyout price; and,
disable the MPS plan.

16. The system according to claim 15, wherein the buyout price is based on one or more of credits, supplies shipped, partially consumed supplies, and terms and conditions of the MPS plan.

17. The system according to claim 15, further including:
one or more databases storing accounting information for a plurality of retailer accounts, including a retailer account of the retailer, and a plurality of MPS accounts, including the MPS account.

18. A computer-implemented method for managing a document processing device of a consumer, said method comprising:
receiving by at least one computer a software agent;
displaying by the at least one computer a graphical user interface (GUI) to the consumer using the software agent, the GUI relating variations of one or more parameters of a managed print service (MPS) plan to average printing purchases of the consumer over a predetermined period of time;
updating by the at least one computer the MPS plan based on a selected variation of a parameter display; and,
purchasing and/or renewing by the at least one computer the updated MPS plan for the document processing device.

19. The method according to claim 18, further comprising:
providing data regarding a remaining life of a consumable of the document processing device, or usage of the document processing device, to a print service system using the software agent.

20. The method according to claim 18, receiving a message with instructions to enable the associated MPS plan before receiving the data.

21. The method according to claim 1, wherein the MPS account is associated with a plurality of MPS plans, each of the MPS plans associated with only one document processing device.

22. The system of claim 15, wherein the MPS plan is an instance of an MPS template plan associated with an account of the retailer.

23. The method of claim 18, wherein the GUI displays gas gauges to convey a relationship between the one or more parameters and the average printing purchases.
